(19) United States
(12) Patent Application Publication
(10) Pub. No.: US 2024/0040124 A1
(43) Pub. Date: Feb. 1, 2024

(54) FLEXIBLE COEFFICIENT CODING IN VIDEO COMPRESSION

(71) Applicant: Apple Inc., Cupertino, CA (US)

(72) Inventors: Alican NALCI, Cupertino, CA (US); Yunfei ZHENG, Santa Clara, CA (US); Hilmi Enes EGILMEZ, Santa Clara, CA (US); Yeqing WU, Cupertino, CA (US); Yixin DU, Milpitas, CA (US); Alexandros TOURAPIS, Los Gatos, CA (US); Jun XIN, San Jose, CA (US); Hsi-Jung WU, San Jose, CA (US); Arash VOSOUGHI, Cupertino, CA (US); Dzung T. HOANG, San Jose, CA (US)

(21) Appl. No.: 18/358,094

(22) Filed: Jul. 25, 2023

Related U.S. Application Data
(60) Provisional application No. 63/392,941, filed on Jul. 28, 2022.

(51) Int. Cl. H04N 19/13; H04N 19/70; H04N 19/61; H04N 19/176

(52) U.S. Cl. CPC H04N 19/13; H04N 19/70; H04N 19/61; H04N 19/176

(57) ABSTRACT

A flexible coefficient coding (FCC) approach is presented. In the first aspect, spatial sub-regions are defined over a transform unit (TU) or a prediction unit (PU). These sub-regions organize the coefficient samples residing inside a TU or a PU into variable coefficient groups (VCGs). Each VCG corresponds to a sub-region inside a larger TU or PU. The shape of VCGs or the boundaries between different VCGs may be irregular, determined based on the relative distance of coefficient samples with respect to each other. Alternatively, the VCG regions may be defined according to scan ordering within a TU. Each VCG can encode a 1) different number of symbols for a given syntax element, or a 2) different number of syntax elements within the same TU or PU. Whether to code more symbols or more syntax elements may depend on the type of arithmetic coding engine used in a particular coding specification. For multi-symbol arithmetic coding (MS-AC), a VCG may encode a different number of symbols for a syntax element. For example, to encode absolute coefficient values inside a TU after performing a transform such as the discrete cosine transform (DCT), a VCG region may be defined around lower-frequency transform coefficients and for that VCG M-symbols can be encoded the absolute coefficient values. Another VCG region can be defined around the higher-frequency transform coefficients to encode K-symbols, where K may be different than M. For binary arithmetic coders (BACs), FCC allows for coding a variable number of syntax elements in different VCGs. In this case, one VCG in a TU may code M-syntax elements associated with signaling the absolute coefficient value, where each one of the M-syntax elements may have 2-symbols. Probability models and context derivation rules may be tailored for each VCG in a given TU or PU. Since each VCG may code a different number of symbols or syntax elements in different spatial locations of a TU or PU, different context models may be used for each VCG to provide better granularity for entropy modeling for arithmetic coding. Furthermore, different VCGs may also use different entropy coders including combinations of arithmetic coding, Golomb-Rice coding, Huffman coding.

### CLAIM FOR PRIORITY

This application benefits from priority of U.S. application Ser. No. 63/392,941, entitled “Flexible Coefficient Coding in Video Compression,” filed Jul. 28, 2022, the disclosure of which is incorporated herein in its entirety.

### BACKGROUND

The present disclosure relates to encoding and decoding of image and video data.

A conventional video codec can compress image and video data for transmission and storage. Some examples of standardized coding specifications include H.264 (AVC), H.265 (HEVC), H.266 (VVC), and AV1. A new video encoding and decoding software, called AOM Video Model (AVM), is currently under development by AOMedia with the intent being that the resulting specification will become the successor to the AV1 specification. Conventional video codecs are block-based and they first partition a video frame or field picture into smaller image regions called as coding blocks. This partitioning is a multi-stage process where a frame is first split into smaller coding-tree units (CTUs) or super-blocks (SBs). A CTU or SB can further be divided into smaller coding blocks (CBs). In FIG. 1, an illustration is provided for an exemplary encoder of the H.266 coding standard. Most video coding specifications including HEVC and AV1 follow a similar logic as in FIG. 1. Following this illustration each input frame is first split into CBs. Although the present discussion focused on frame pictures, the principles of the present discussion applies also to field pictures, which may be used for interlace coding applications.

After the partitioning stage, a video encoder can predict pixel samples of a current block from neighboring blocks by using intra prediction. Alternatively or additionally, a codec may also use pixel information and blocks from previously coded frames/pictures by using inter prediction techniques. Some of the commonly used inter prediction techniques include weighted or non-weighted single or multi-hypothesis motion compensated prediction, temporally interpolated prediction, or hybrid modes that can use both inter and intra prediction. Prediction may involve simple motion models, e.g., translation only, or more complex motion models such as an affine model. The prediction stage aims to reduce the spatial and/or temporally redundant information in coding blocks from neighboring samples or frames/pictures. The resulting block, after subtracting the predicted values (e.g. with intra or inter prediction) from the block of interest, is usually called the residual block. The encoder may further apply a transformation on the residual block using variants of the discrete cosine transform (DCT), discrete sine transform (DST), or other possible transforms, including for example wavelet transforms. The block on which a transform is applied is usually referred to as a transform unit (TU).

The transform stage provides energy compaction in the residual block by mapping the residual values from the pixel domain to some alternative vector or Euclidean space. This stage helps reduce the number of bits required to transmit the energy-compacted coefficients. It is also possible for an image or video codec to skip the transform stage. Usually, this is done if performing a transform on the residual block is found not to be beneficial, for example in cases when the residual samples after prediction are found to be already compact enough. In such a case a DCT-like transform might not provide additional compression benefits.

After the transform stage, the resultant coefficients are passed through a quantizer, which reduces the number of bits required to represent the transform coefficients, while at the same time introducing some form of distortion into the signal. Optionally, optimization techniques such as trellis-based quantization, adaptive rounding, or dropout optimization/coefficient thresholding, in which certain coefficients that may be less significant or are deemed to be too costly to encode while providing potentially minimal benefit to the subjective quality of a partition are thrown away, can be employed to tune the quantized coefficients based on some rate-distortion and/or other (e.g., complexity) criteria. The quantization stage can cause significant loss of information especially at low bitrate constraints. In such cases, quantization may lead to visible distortion or loss of information in images/video. The tradeoff between the rate (amount of bits sent over a time period) and distortion is often controlled with a quantization parameter (QP). In the entropy coding stage, the quantized transform coefficients, which usually make up the bulk of the final output bitstream, are signaled to the decoder using lossless entropy coding methods such as the multi-symbol arithmetic coding (MS-AC) in AV1/AVM, the context-adaptive binary arithmetic coding (CABAC) in EVC and VVC, or other entropy coding methods.

In addition to the quantized coefficients, certain encoder decisions are signaled to the decoder as side information. Some of this information may include partitioning types, intra and inter prediction modes (e.g. weighed intra prediction, multi-reference line modes, etc.), the transform type applied to transform blocks, and/or other flags/indices pertaining to tools such as a secondary transform. This side information usually accounts for a smaller portion of the final bitstream as compared to quantized transform coefficients. The decoder uses all of the information above to perform an inverse transformation on the de-quantized coefficients and reconstruct the pixel samples. Additional tools, including restoration, de-blocking, and loop-filters, may also be applied on the reconstructed pixel samples to enhance the quality of reconstructed images.

### Transform Types in AV1/AVM

In the AVM reference software, several transform candidates are possible. These options consist of a combination of 1) the discrete cosine transform (DCT), 2) the asymmetric discrete sine transform (ADST), 3) the flipped ADST, and 4) the Identity transform (IDTX). These transforms can be applied either in 1 dimension (1D), e.g., horizontally or vertically, or alternatively can be applied both horizontally and vertically with 2D transforms as summarized in Table 1 below. Except for the IDTX transform, all transform types in Table 1 apply a transform kernel along either the vertical or horizontal direction. In the AVM, a secondary transform called the “intra secondary transform” (IST) is currently under consideration. This secondary transform is applied as a non-separable transform kernel on top of the primary transform coefficients based on a mode decision.

### Coefficient Coding in AV1/AVM

TABLE 1
Transform Types in AV1 and AVM

| | Transform | Vertical | Horizontal |
|---|---|---|---|
| | Type | Mode | Mode |
| DCT_DCT | 2D | DCT | DCT |
| ADST_DCT | 2D | ADST | DCT |
| DCT_ADST | 2D | DCT | ADST |
| ADST_ADST | 2D | ADST | ADST |
| FLIPADST_DCT | 2D | Flipped ADST | DCT |
| DCT_FLIPADST | 2D | DCT | Flipped ADST |
| FLIPADST_FLIPADST | 2D | Flipped ADST | Flipped ADST |
| ADST_FLIPADST | 2D | ADST | Flipped ADST |
| FLIPADST_ADST | 2D | Flipped ADST | ADST |
| IDTX | 2D | Identity | Identity |
| V_DCT | 1D | DCT | Identity |
| H_DCT | 1D | Identity | DCT |
| V_ADST | 1D | ADST | Identity |
| H_ADST | 1D | Identity | ADST |
| V_FLIPADST | 1D | Flipped ADST | Identity |
| H_FLIPADST | 1D | Identity | Flipped ADST |

Regardless of the transform type selected by an encoder the resulting coefficients from the transform stage or prediction residuals (if IDTX is used) need to be signaled to the decoder. In the AVM, coefficient coding can be summarized in 4 main parts: 1) scan order selection, 2) coding of the last coefficient position, 3) level and sign derivation, and 4) context-based coefficient coding.

### Scan Order Selection:

AV1 currently implements 5 default scans: an up-right diagonal scan, a bottom-left diagonal scan, a Zig-zag scan, a column scan, and a row scan. These scans determine the order in which the coefficients are signaled to the decoder. Examples of the zig-zag, row, and column scans are illustrated in FIG. 2 for a transform block size of 4×4. AV1 can use both the forward and the reverse versions of these scans depending on the coding pass. The reverse Zig-zag scan is also illustrated in FIG. 2 in the second column. The selected scan order depends on the transform type used as shown in Table 1 and also on the block size/shape of a TU. For instance, 2D transforms such as the DCT DCT may use a zig-zag scan order to map the 2D coefficient values into a single array. This mapping can be either forward or reverse as shown in FIG. 2. The coefficient coding traverses the coefficient in the selected scan order during the entropy coding stage.

### Coding of the Transform Type and Last Coefficient Position:

Before coding the coefficients, AV1 and AVM first determine the last position of the most significant coefficient in a transform block, or the coefficient location end-of-block (EOB). If the EOB value is 0, the transform unit does not have any significant coefficients and nothing needs to be coded for the current transform unit. In this case, only a skip flag (all zero syntax element) is signaled that indicates whether the EOB is 0 or 1.

If the EOB value is non-zero, then a transform type is coded only for luma blocks. Additionally an intra secondary transform (IST) flag may be signaled based on the luma transform type. The latter two syntax elements let the decoder know all the necessary details to compute an inverse transform.

Then the last coefficient position is explicitly coded. This last position determines which coefficient indices to skip during the scan order coding. To provide an example, if EOB=4 for a left-most transform block in FIG. 2, then only coefficient indices of 0, 1, 2, 3 are coded according to the Zig-zag scan order. Other coefficient indices (>4), as determined by the scan order, are not visited during the coefficient coding stage.

### Level Mapping and Sign Derivation:

If a coefficient needs to be coded, a transform coefficient is first converted into a ‘level’ value by taking its absolute value. For square blocks with 2D transforms a reverse Zig-zag scan is used to encode the level information. This scan starts from the bottom right side of the transform unit in a coding loop (e.g., starting from the EOB index until the scan index hits 0) as in the second column of FIG. 2. The level values are positive and usually signaled to the decoder in multiple coding passes as follows:
a. Base Range (BR): This covers level values of 0, 1, 2, and 3. If a level value is less than 3, consequently the level coding loop terminates here and coefficient coding does not visit the Low/High ranges as discussed next. A value of 3 indicates that the level value can be equal or greater than 3 for BR pass. The level values are context coded depending on the neighboring level values and other parameters such as the transform size, plane type, etc.
b. Low Range (LR): This range covers level values between [3-14]. The level values are context coded depending on the neighboring level values and other parameters such as transform size, plane type, etc.
c. High Range (HR): This range corresponds to level values greater than 15. The level information beyond 15 is coded with Exp-Golomb code without using contexts.

After the level value is coded in reverse scan order, the sign information is coded separately using a forward scan pass over the significant coefficients. The sign flag is bypass coded with 1 bit per coefficient without using probability models. The motivation of bypass coding here is to simplify entropy coding since DCT coefficients usually have random signs.

### Context-Based Level Coding:

In AV1, the level information is encoded with a proper selection of contexts or probability models using multi-symbol arithmetic encoding. These contexts are selected based on various parameters such as transform size, plane (luma or chroma) information, and the sum of previously coded level values in a spatial neighborhood. FIG. 3 shows several examples of how the contexts are derived based on neighboring level values. For BR coding pass with Zig-zag scan, level value for scan index #4 can be encoded by using the level values in a predetermined neighborhood (shown as locations 7, 8, 10, 11, 12). The level values in this neighborhood are summed to select an appropriate probability mode or a context index for arithmetic coding. Likewise, 1D transforms can only access the previously decoded 3 neighboring samples. Low Range coding constrains the context derivation neighborhood for 2D transforms to be within a 2×2 region.

### Forward Skip Coding:

The AVM further implements a forward skip coding (FSC) mode that improves coding of prediction residuals when the IDTX (identity) transform is used. This technique moves the signaling of the IDTX transform flag from the TU level to the CB level and uses an alternative residual coding method [3, 4]. For FSC coded blocks, an explicit trigonometric transform is skipped both for columns and rows of a transform unit. As shown in FIG. 4, FSC uses a forward scan order that is used with a 2-sample context derivation neighborhood for level coding passes and a 3-sample context derivation neighborhood for sign coding.

### BRIEF DESCRIPTION OF THE DRAWINGS

FIG. 1 is a block diagram of an H.266-based video encoder into which the techniques proposed in the present disclosure may be applied.

FIG. 2 illustrates scan orders supported by AV1, including a zig-zag scan (FIG. 2(a), a reverse zig-zag scan (FIG. 2(b)), a column order scan (FIG. 2(c)), and a row order scan (FIG. 2(d)).

FIG. 3 illustrates context derivation neighborhoods for coding base range levels (FIG. 3(a)) and low range levels (FIG. 3(b)), respectively.

FIG. 4 illustrates context derivation neighborhoods for forward skip coding in an AOM Video Model for level and sign coding.

FIG. 6 illustrates concepts of flexible coefficient coding and definitions of variable coefficient groups according to embodiments of the present disclosure.

FIG. 7 illustrates exemplary variable coefficient groups according to embodiments of the present disclosure. FIG. 7(a) illustrates an 8×8 transform unit partitioned into two variable coding groups according to a first embodiment, FIG. 7(b) illustrates an 8×8 transform unit partitioned into two variable coding groups according to a second embodiment, and FIG. 7(c) illustrates an 8×8 transform unit partitioned into two variable coding groups according to a third embodiment.

FIG. 8 illustrates exemplary variable coefficient groups according to embodiments of the present disclosure. FIG. 8(a) illustrates an 8×8 transform unit partitioned into three variable coding groups according to a first embodiment, FIG. 8(b) illustrates an 8×8 transform unit partitioned into three variable coding groups according to a second embodiment, and FIG. 8(c) illustrates an 8×8 transform unit partitioned into three variable coding groups according to a third embodiment.

FIG. 9 illustrates exemplary variable coefficient groups according to other embodiments of the present disclosure. FIG. 9(a) illustrates an 8×8 transform unit partitioned into variable coefficient groups according to a zig-zag scan, and FIG. 9(b) illustrates an 8×8 transform unit partitioned into variable coefficient groups according to an up-right diagonal scan.

FIG. 10 illustrates exemplary variable coefficient groups according to further embodiments of the present disclosure. FIG. 10(a) illustrates an 8×8 transform unit partitioned into two variable coefficient groups in which a first variable coefficient group is allocated a first number of symbols for level coding and a second variable coefficient group is allowed a second number of symbols for level coding. FIG. 10(b) illustrates an 8×8 transform unit partitioned into two variable coefficient groups in which a first variable coefficient group is allocated a first number of symbols for level coding that is different than the allocation illustrated in FIG. 10(a) and a second variable coefficient group is allocated a second number of symbols for level coding that, again, is different than the allocation illustrated in FIG. 10(a). FIG. 10(c) illustrates an 8x8 transform unit partitioned into four variable coefficient groups in which each variable coefficient group is allocated a respective number of symbols for level coding.

FIG. 11 illustrates examples of non-square transform units in which different variable coefficient groups are allocated different symbol counts. FIG. 11(a) illustrates two variable coefficient groups and FIG. 11(b) illustrates three variable coefficient groups.

FIG. 12 illustrates examples of transform units in which multiple variable coefficient groups, where each variable coefficient group contains multiple syntax elements but with each syntax element having 2-symbols. In FIG. 12(a), the variable coefficient groups are shown having an irregular shape, in FIG. 12(b), the variable coefficient groups are shown having a rectangular shape with their longest dimension aligned with rows of the transform unit, and, in FIG. 12(c), the variable coefficient groups are shown having a rectangular shape with their longest dimension aligned with columns of the transform unit.

FIG. 13 illustrates context derivation regions and rules associated with two dimensional transforms as in AV1.

FIG. 14 illustrates exemplary context derivation regions and rules associated with different variable coefficient groups according to an embodiment of the present disclosure. FIG. 14(a) illustrates an exemplary context derivation region for a first variable coefficient group, FIG. 14(b) illustrates an exemplary context derivation region for a second variable coefficient group, and FIG. 14(c) illustrates an exemplary context derivation region for a third variable coefficient group.

FIG. 15 illustrates exemplary variable coefficient group splits for a coding transform unit, coding unit, and/or prediction unit that is split into multiple variable coefficient groups. FIG. 15(a) illustrates an example in which a block is partitioned into three variable coefficient groups, FIG. 15(b) illustrates another example in which a block is partitioned into a first exemplary set of two variable coefficient groups, and FIG. 15(c) illustrates a further example in which a block is partitioned into another exemplary set of two variable coefficient groups.

FIG. 16 illustrates a decoding system that may find application with the aspects of the present disclosure.

### DETAILED DESCRIPTION

### Introduction

In this disclosure, a flexible coefficient coding (FCC) approach is presented. FCC has three main aspects. In the first aspect, an encoder may dynamically define spatial sub-regions over a transform unit (TU) or a prediction unit (PU). These sub-regions may organize the coefficient samples residing inside a TU or a PU into variable coefficient groups (VCGs). Each VCG may correspond to a sub-region inside a larger TU or PU. The shape of VCGs or the boundaries between different VCGs may be determined based on the relative distance of coefficient samples with respect to each other. Alternatively, the VCG regions may be defined according to scan ordering within a TU. VCGs may differ from traditional coefficient groups due to the variations in entropy coding techniques associated within each VCG and specialized operations each VCG may perform.

In the second aspect, an encoder may allocate to each VCG: 1) a different number of symbols for a given syntax element, and/or 2) a different number of syntax elements within the same TU or PU. The decision whether to allocate more symbols or more syntax elements may depend on the type of arithmetic coding engine used in a particular coding specification. For multi-symbol arithmetic coding (MS-AC), a VCG may allocate a different number of symbols for a syntax element. For example, to encode absolute coefficient values inside a TU after performing a transform such as the discrete cosine transform (DCT), a VCG region may be defined around lower-frequency transform coefficients and for that VCG M-symbols can be encoded the absolute coefficient values. Another VCG region can be defined around the higher-frequency transform coefficients to encode K-symbols, where K may be different than M. For binary arithmetic coders (BACs), FCC allows for coding a variable number of syntax elements in different VCGs. In this case, one VCG in a TU may code M-syntax elements associated with signaling the absolute coefficient value, where each one of the M-syntax elements may have 2-symbols.

The third aspect described in this disclosure allows for applying, by an encoder, specialized and different probability models and context derivation rules associated with each VCG in a given TU or PU. Since each VCG may code a different number of symbols or syntax elements in different spatial locations of a TU or PU, different context models may be used for each VCG to provide better granularity for entropy modeling for arithmetic coding. Furthermore, different VCGs may also use different entropy coders including combinations of arithmetic coding, Golomb-Rice coding, Huffman coding. The FCC proposed here can be used in new image and video coding specifications and their implementations such as extensions of HEVC (H.265) and VVC (H.266) from MPEG/ITU-T, or of AV1 by the Alliance for Open Media (AOM) such as its successor development model AVM (AOM Video Model).

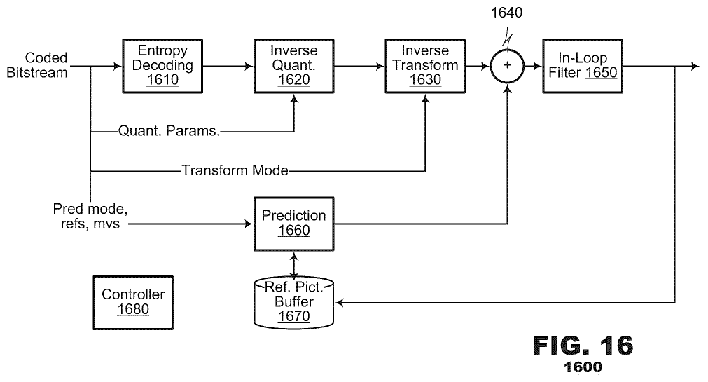

FIG. 5 illustrates a method 500 according to an embodiment of the present disclosure. The method 500 may be run by an encoder in a video coding system. The method 500 may begin by coding an input block as a block of coefficients (box 510). The method 500 may partition the block of coefficients into a plurality of coding groups (box 520). For each coding group developed in box 520, the method 500 may determine a coding context for the group (box 530) and may code coefficients of the coding group according to coding rule(s) developed from the block's coding context (box 540). The following discussion presents variations of this method 500. During decoding, a decoder (FIG. 16) may operate according to a reciprocal method that inverts operations of the method 500 and recovers coefficients of the coding groups according to the coding rule(s) applied by the encoder, then by assembling a recovered block from the coding groups' recovered coefficients.

### Proposed Flexible Coefficient Coding Scheme

In the present disclosure, a new flexible coefficient coding method is described for video encoders and decoders. FCC introduces the concept of variable coefficient groups (VCGs). A single VCG may be defined as a spatial sub-region of a TU or PU with variable shapes. Each VCG may be associated with different entropy coding approaches. For instance a VCG may code a variable number M of symbols or syntax elements attached specifically to itself to encode information. A VCG may also be associated with different entropy modeling and context derivation rules specific to itself to improve the arithmetic coding performance. An example of information that VCGs can code is level information, which is defined as the absolute value of transform coefficient samples or prediction residual samples. In this regard, application of VCGs may differ from traditional coefficient coding, since, in standard codecs, the same number of symbols or syntax elements and mostly the same entropy and context derivation rules within the same TU are used. For instance, in both the AV1 and AVM reference software, the level value for a single coefficient is split into different level ranges and then coded in multiple coding passes using MS-AE. These ranges or coding passes are defined as the base range (BR), low range (LR), and high range (HR) in the Background. However, both BR and LR passes in the AVM use 4-symbols for a given TU or PU regardless of the coefficient location and context derivation rules do not vary across different sub-regions within the same TU. FCC modifies the entropy coding process depending on the defined VCGs.

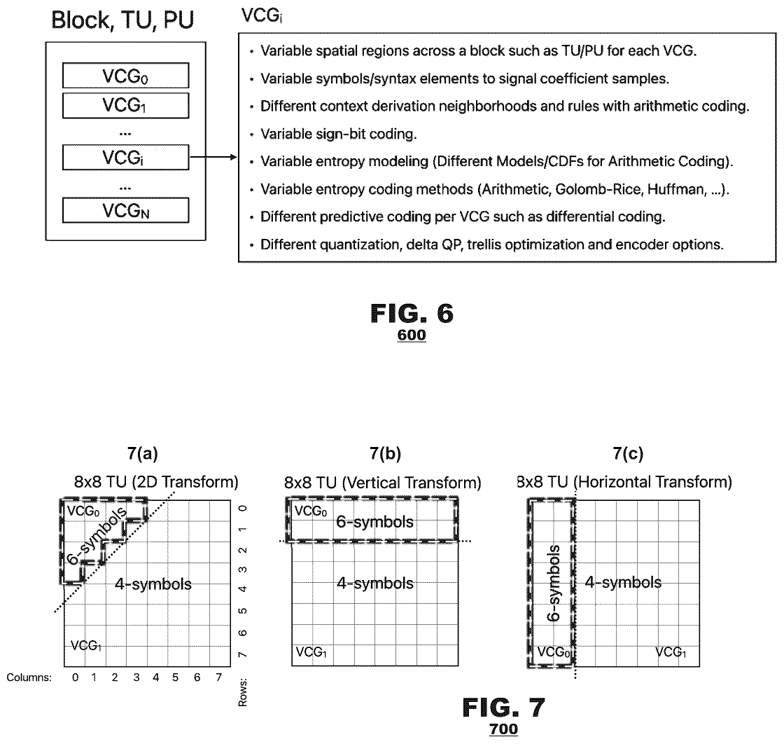

FIG. 6 illustrates and summarizes several aspects of FCC and VCGs. In this figure, a block such as a TU or a PU may contain multiple VCGs. Each VCGᵢ may correspond to spatial regions that are a part of the TU or PU and may vary in shape. These regions may or may not be overlapping. Each VCGᵢ may have variable Mᵢ-symbols or variable syntax elements associated with signaling a particular type of information. In one case, an MS-AC may use Mᵢ-symbols in VCGᵢ to signal level information. In another case, a BAC may use Mᵢ syntax elements (each having 2 symbols) to code coefficient level information. Each VCGᵢ may have different context derivation neighborhoods and different context index derivation rules to determine a set of probability models for arithmetic coding. Each VCG may have different handling for sign coding, for instance VCGᵢ may use context coding to transmit the sign bit if coefficients reside under VCGᵢ. However, a different VCGᵢ may use bypass coding, or context coding with different context derivation rules. A VCGᵢ may code coefficient information in multiple Pᵢ passes.

In AV1, 3 such passes are used such as BR, LR, and HR coding. In FCC, Pᵢ may have different coefficient coding passes and different symbols/syntax elements associated with each pass. Alternatively, different VCGs may utilize different entropy coding methods. For instance, VCGᵢ may use a combination of Arithmetic coding and Golomb-Rice coding, whereas a VCGⱼ may use Huffman coding or different entropy coding methods. VCGs may have different quantizers, quantization matrices, quantization step sizes, delta QPs derived or signaled, and encoder optimizations such as making use of trellis optimization. Moreover, VCGs may use different predictive coding techniques such as DPCM.

The FCC technique may find application in several embodiments, which are described below.

In the proposed design, the number of symbols (N) encoded to represent a level value in a given coding range (e.g. BR, LR in AVM) or a coefficient coding pass can depend on the relative spatial sub-region (VCG) in a TU or a PU. To provide an example, in FIG. 7(a), given an 8×8 TU a top-left shaded triangular region is defined. This region is defined as a VCG with index k=0; the remainder of the TU belongs to a VCG with index k=1. In VCGₖ₌₀, a 6-symbol syntax element may be used to encode the level values. For the VCG₁ shown in FIG. 7(a), 4-symbols can be used for the BR pass. In one example, given a coefficient residing inside the VCG₀ region, a BR coefficient coding pass can encode level values within range [0, 1, 2, 3, 4, 5). In the remaining VCG₁ region (outside the top-left triangular area), however, a BR pass may indicate that the level value is within [0, 1, 2, 3) that corresponds to 4 symbols. The symbol of coded N-symbols per VCG can be implicitly defined based on the VCG index without signaling and can be variable, alternatively this the number of N may be signaled per VCG at the start of each VCG, or at the higher levels such as tile-level, CTU level, sequence, picture or frame levels. This will be explained further below.

In one example, an additional LR coding pass can be performed after the 6-symbol BR pass on VCG₀ in FIG. 7(a). This additional pass is performed to encode level values greater than 5. For instance, an additional 4-symbol syntax element can be coded in a LR pass with a loop (L=[L_1, L_2, L_i, L_N]) after the 6-symbol BR pass, where a sub-range of LR is defined as LR_i=5+[0, 1, 2, 3]×i and N is the number of total sub-ranges to code. If N=1 then L=[L_1] and the LR pass will cover the additional level values [5, 6, 7, 8] after the BR region. Similarly, if N=2, then L=[L_1, L_2] and the LR will cover values [5, 6, 7, 8, 9, 10, 11, 12].

In one example, the LR loop can code a maximal of M-symbols for each sub-range loop. M can be different in VCG₀ in FIG. 7(a) as compared to the other VCGₖ's, where N-symbols can be used for coding the LR loop. In one example, each VCGₖ can encode Mₖ-symbols for the BR pass and Nₖ-symbols for the LR pass, where M, N, and k are arbitrary numbers.

In a preferred embodiment, the shape of VCG₀ can be determined by the encoder and decoder based on the underlying coefficient's relative location inside a given TU or PU. For instance, in FIG. 7(a), VCG₀ corresponds to the region defined by (R+C<=3), where the sum of the row (R) and column (C) indices in FIG. 7(a) are less than or equal to 4 (e.g. region above the top-left dashed-lines).

In a preferred embodiment, if a 1D transform is applied along a single direction, such as a vertical DCT (V_DCT) or horizontal ADST (H_ADST) as shown in Table 1, then the bulk of coefficients may reside in different regions of a TU as compared to the 2D transform example. In this case, the VCG regions can be determined differently from the 2D transform case. This is shown in FIGS. 7(b) and 7(c), where the 6-symbol VCG₀ region has a row limit rule of (R<2) in FIG. 7(b). Application of a column limit rule of (C<2) is used in FIG. 7(c).

In one embodiment, variations to the spatial regions defined by VCGs and the variations to the number of symbols associated with each VCG are allowed. For instance, in FIG. 8(a), a 2-symbol VCG₂ is defined around the bottom-right part of an 8×8 TU. In this region, which can be characterized by (R+C>7), only 2 symbols are used in the BR coefficient coding pass. This additional VCG may improve the throughput of a codec since a fewer number of symbols need to be encoded and parsed if the level values in this region are mostly less than or equal to 1. Similarly, in FIGS. 8(b) and 8(c), extensions of the 2-symbol region to the horizontal or vertical 1D transform cases are shown. The decoder infers a VCG region based on the location of underlying coefficients e.g. by looking at the R+C sums of coefficients under a VCG.

In another embodiment, different color components (for example luma and chroma) are allowed to use different spatial regions defined by VCGs, different number of symbols associated with each VCG and a different number of passes. For example, in FIG. 8(a), luma may use three VCGs but chroma may use only 2 VCGs. This embodiment exploits characteristics of video in which the number of zero transform coefficients in mid and high frequency regions is typically larger for chroma than luma. This design reduces the computational complexity, reduces the number of probability models used for Chroma, and may even provide a minor coding gain. Employing more probability models is usually useful when they are used (and thus updated) frequently, otherwise a system may end up having many probability models which are not accurate enough to capture the true statistics of the transform coefficients. As another example of treating different color components differently, in FIG. 8(a), VCG₀ may use 6 symbols for luma while it may use 4 symbols for chroma. Since the dynamic range of chroma BR is lower than that of luma BR, using fewer symbols for chroma may improve the throughput of a codec and may even improve the coding gain.

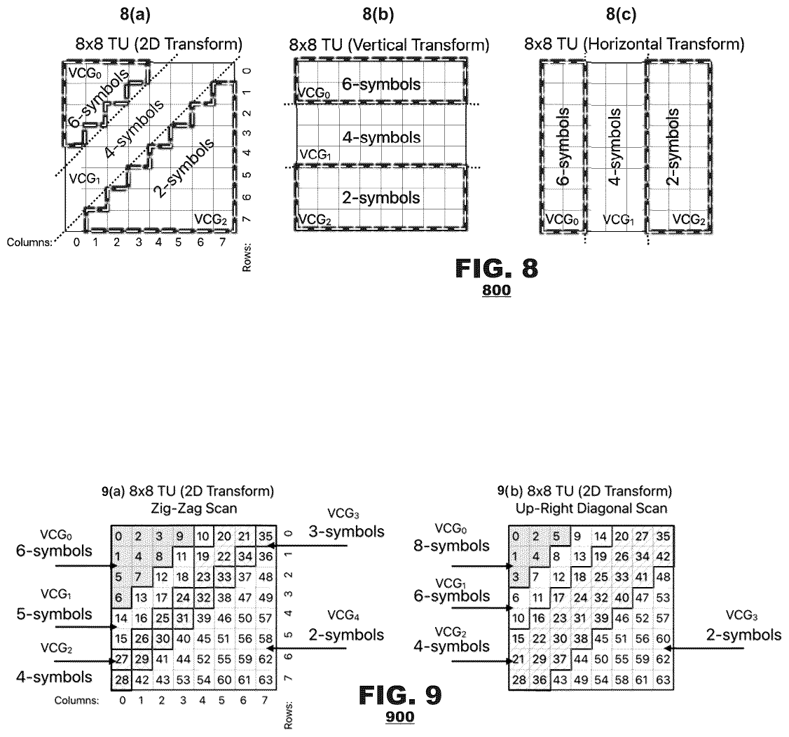

In a further embodiment, the VCG regions can be determined by the scan indices of the underlying coefficients. An example for this case is shown in FIG. 9(a), where a Zig-zag scan is used. In this case, a VCG₀ can be defined to contain coefficients that correspond to scan indices from {0, 1, 2, . . . 9} and in this region the level values can be coded with 6-symbols. Another VCG₁ that ranges from coefficient indices {10, 11, . . . , 18} can be defined and coded with 5-symbols. A VCG₂ may correspond to scan indices {19, . . . , 27}, which are coded with 4 symbols. Similarly, level values in VCG₃ {28, . . . , 36} are coded with 3 symbols and in VCG₄ {37, . . . , 63} are coded with binary symbols. This shows that in the respective scan order arbitrary spatial regions can be defined and each region may have a different or variable number of coded symbols associated with it. In FIG. 9(b), an example is shown for the up-right diagonal scan.

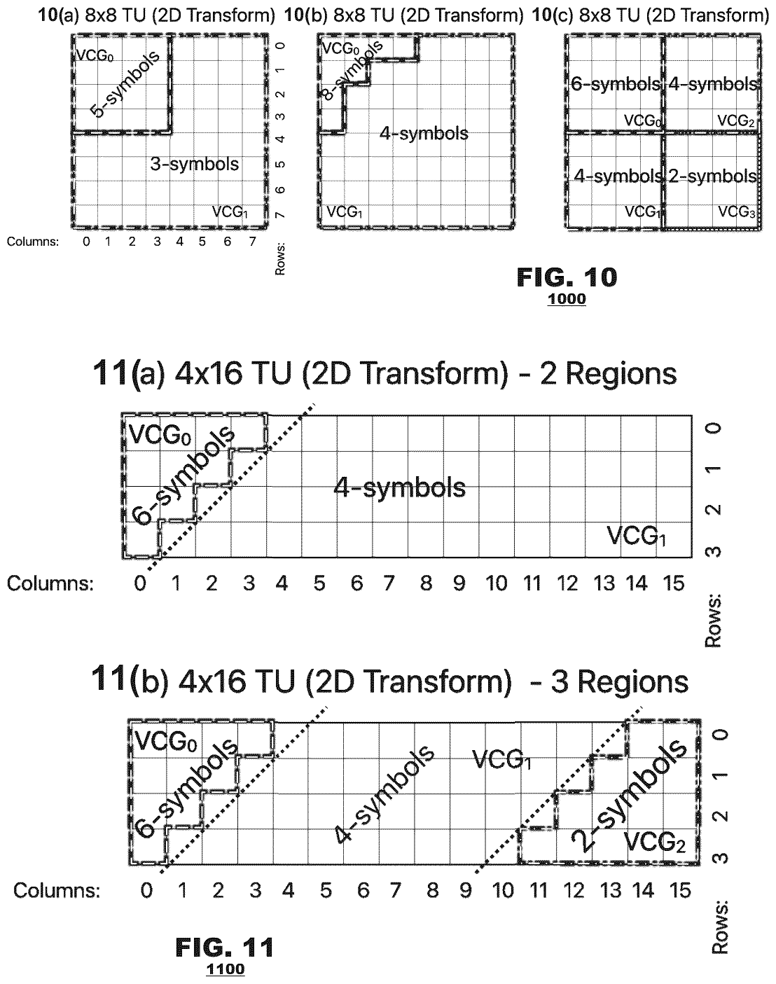

Some potential variations to VCG regions are shown in FIG. 10. In FIG. 10(a), a top-left 4×4 VCG₀ uses 5 symbols for level coding and the level values in the remaining VCG₁ are coded with 3 symbols. In FIG. 10(b), a top-left VCG₀ region uses 8 symbols in a smaller coefficient region. In FIG. 10(c), an 8×8 TU is split into equal sized 4×4 VCGs and the coefficients in each VCG are coded with different symbol counts.

The ideas described above can apply to arbitrary block sizes of N×M. An example is shown in FIG. 11(a), where the TU size is 4×16 and a 6-symbol VCG is defined such that VCG₀=(R+C<T). That is, the row and column index sums are less than a threshold T=4. In FIG. 11(b), another VCG₂ is defined on the right-hand side in which levels values can be coded with 2 symbols. This VCG₂ region can be obtained by the rule (R+C)>(max(W=16, H=4)−T) where T=2 and the max operator selects the maximum of width or height of the TU. A threshold of 2 is applied to define the 2-symbol VCG₂ region. Note that alternatively, VCG regions can be determined based on the scan index ordering as shown in FIG. 9 but for non-square blocks as well.

As another example, VCG regions of non-square blocks of 2D transforms may be defined differently than those of square blocks. For example, in FIG. 11(a), for a TU size 4×16, the VCG region may be defined as VCG0=(4*R+C<T). This reduces the slope of the VCG boundary line from 1 to 0.25 so that more coefficients along the x-axis are included in the VCG region. This is a better clustering of the transform coefficients with similar statistics into one VCG.

In one example, a larger TU or PU can be split into equal sized coefficient groups (CGs) as done in HEVC or VVC. The concept of VCGs extends and generalizes CGs in the sense that with VCGs each CG can have a variable number of symbols coded to represent particular information and may have a different entropy coding process with some examples detailed in FIG. 6. Furthermore, a different as compared to CGs; VCGs may also be defined over a CU or a PU, where a single VCG may contain one or more TUs, and inside each VCG the residual coding process can be shared via inference rules or can be differentiated via signaling.

In an alternative embodiment, the coefficients in a 2D TU, PU can be vectorized to form a 1 dimensional array. In this case, the variable symbol coding can work on coefficient indices directly rather than dividing the 2D TU, PU, or CG based on row or column indexes.

In another embodiment, different VCGs may share the same entropy coding methods but may have different context derivation rules.

### Extension to Binary Arithmetic Coders:

Instead of coding a variable number of symbols in each VCG, a different number of syntax elements can be coded in each different VCG. For instance, in both HEVC (H.265) and VVC (H.266) a context-adaptive binary arithmetic coding (CABAC) engine is used. CABAC can only transmit a maximum of 2 context coded symbols per syntax element in the bitstream, therefore it is not possible to modify the number of symbols per syntax element across different VCGs. However, a variable number of syntax elements to transmit a particular information such as coefficient level values may be coded in each VCG.

Table 2 summarizes syntax elements signaled for level coding in VVC. In this table a quantized coefficient value at a scan index k is defined as qₖ and its absolute value is defined as |qₖ|. The first row shows the actual value of quantized level values to be encoded. First, in VVC's coefficient coding a significance flag (sig) is coded, which indicates if the level value is non-zero at coefficient index k. This sig syntax is a 2-symbol element. If sig=0 then no other syntax element is coded for the level value at coefficient index k. If sig is non-zero, then another, greater than 1, (gt1) syntax element is coded that indicates whether a level value is larger than 1. Consequently, a parity flag (par) and a greater than 3 (gt3) flag may be coded conditioned on the values of the previous syntax elements. Lastly, a remainder (rem) term is coded in bypass coding mode to represent larger level values. Note that the transform skip residual coding in VVC may code a different number of syntax elements.

TABLE 2
Level binarization used in VVC to transmit
absolute values of quantized coefficients.

| \|qₖ\| | 0 | 1 | 2 | 3 | 4 | 5 | 6 | 7 | 8 | 9 | . . . |
|---|---|---|---|---|---|---|---|---|---|---|---|
| sig | 0 | 1 | 1 | 1 | 1 | 1 | 1 | 1 | 1 | 1 | . . . |
| gt1 | — | 0 | 1 | 1 | 1 | 1 | 1 | 1 | 1 | 1 | . . . |
| par | — | — | 0 | 1 | 0 | 1 | 0 | 1 | 0 | 1 | . . . |
| gt3 | — | — | 0 | 0 | 1 | 1 | 1 | 1 | 1 | 1 | . . . |
| rem | — | — | — | — | 0 | 0 | 1 | 1 | 2 | 2 | . . . |

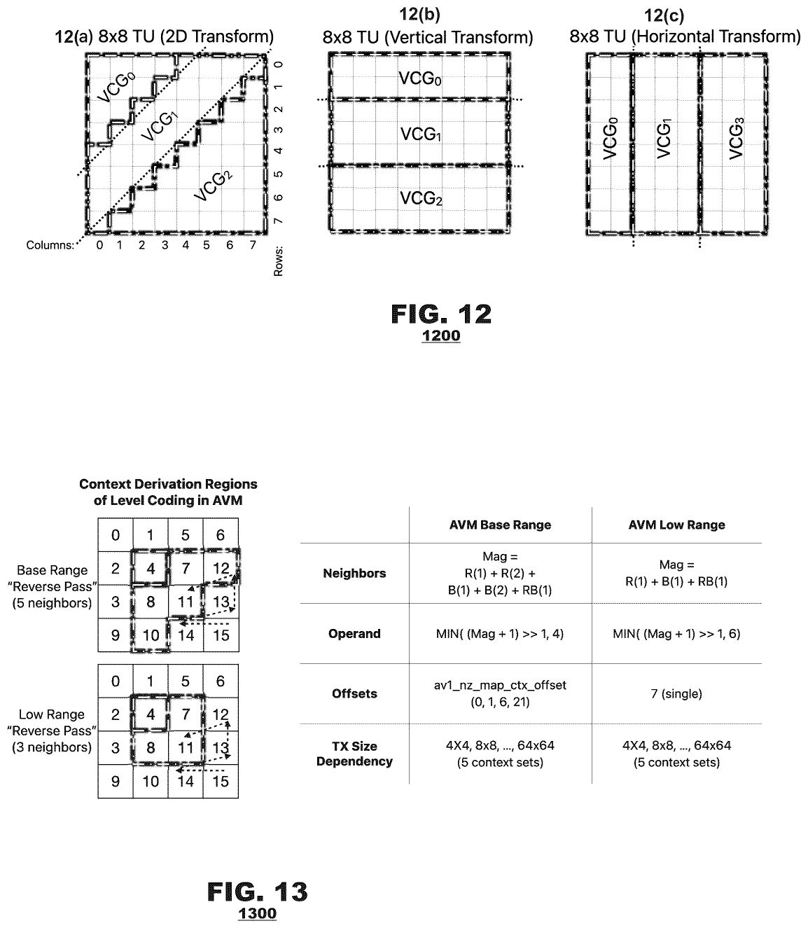

In the proposed FCC design, different VCGs may code a different number of syntax elements, where each syntax element may have 2-symbols. FIG. 12 shows a simple example of an 8×8 TU case where different VCG₀, VCG₁, and VCG₂ regions are illustrated. In Table 3, the syntax elements encoded for VCG₀ region are summarized. Based on the actual level value |qₖ| the following syntax elements are coded for VCG₀: sig, gt1, par, gt3, gt5, and rem. Here the gt5 term is a newly defined syntax element for VCG₀ and is context-coded to indicate if the level value is greater than 5—no other VCG in this example has this gt5 syntax. In Table 4, syntax elements are shown to encode a level value for VCG₁. This does not include gt5 and is the same as the current VVC syntax elements. In Table 5, syntax elements are shown only for VCG₂, which only include the sig and gt1 syntax elements. As common to all regions, a remainder term can be coded in bypass mode to represent the remaining level values.

TABLE 3
Binary syntax elements coded for various level
values for VCG₀

| \|qₖ\| | 0 | 1 | 2 | 3 | 4 | 5 | 6 | 7 | 8 | 9 | 10 | 11 | . . . |
|---|---|---|---|---|---|---|---|---|---|---|---|---|---|
| sig | 0 | 1 | 1 | 1 | 1 | 1 | 1 | 1 | 1 | 1 | 1 | 1 | . . . |
| gt1 | | 0 | 1 | 1 | 1 | 1 | 1 | 1 | 1 | 1 | 1 | 1 | . . . |
| par | | | 0 | 1 | 0 | 1 | 0 | 1 | 0 | 1 | 0 | 1 | . . . |
| gt3 | | | 0 | 0 | 1 | 1 | 1 | 1 | 1 | 1 | 1 | 1 | . . . |
| gt5 | | | | | 0 | 0 | 1 | 1 | 1 | 1 | 1 | 1 | . . . |
| rem | | | | | | | 0 | 0 | 1 | 1 | 2 | 2 | . . . |

TABLE 4
Binary syntax elements coded for various
level values for VCG₁

| \|qₖ\| | 0 | 1 | 2 | 3 | 4 | 5 | 6 | 7 | 8 | 9 | . . . |
|---|---|---|---|---|---|---|---|---|---|---|---|
| sig | 0 | 1 | 1 | 1 | 1 | 1 | 1 | 1 | 1 | 1 | . . . |
| gt1 | | 0 | 1 | 1 | 1 | 1 | 1 | 1 | 1 | 1 | . . . |
| par | | | 0 | 1 | 0 | 1 | 0 | 1 | 0 | 1 | . . . |
| gt3 | | | 0 | 0 | 1 | 1 | 1 | 1 | 1 | 1 | . . . |
| rem | | | | | 0 | 0 | 1 | 1 | 2 | 2 | . . . |

TABLE 5
Binary syntax elements coded for various
level values for VCG₂

| \|qₖ\| | 0 | 1 | 2 | 3 | 4 | 5 | . . . |
|---|---|---|---|---|---|---|---|
| sig | 0 | 1 | 1 | 1 | 1 | 1 | . . . |
| gt1 | | 0 | 1 | 1 | 1 | 1 | . . . |
| rem | | | 0 | 1 | 2 | 3 | . . . |

In general, each VCG may have an arbitrary number of coded syntax elements that may be different from each other. The number of added syntax elements associated with each VCG may be selected based on where the coefficient level values are concentrated and also, some VCGs may code less syntax elements if the coefficient level values in the respective VCG regions are sparse (or lesser in magnitude).

### Specialized Context Derivation Rules in Different Regions:

Once the optimal symbol counts or syntax elements are chosen for each VCG, the second aspect proposed in this disclosure is to assign different probability models and entropy modeling for arithmetic coding for each region.

For instance in the AVM, context derivation neighborhoods were previously shown in FIG. 3 for BR and LR coding passes for coding of transform coefficients. FIG. 13 reproduces and further details the context derivation neighborhoods again for 2D transforms for BR and LR passes for the AVM for the 2D transform case. For BR, to encode the coefficient level value at index #4 a total of 5 neighboring samples (7, 8, 10, 11, 12) are used. That is, the magnitude sum of the previously decoded level values is first computed across the 5-sample neighborhood as shown in the table provided in FIG. 13 as Mag=R(1)+R(2)+B(1)+B(2)+RB(1), where R(1) refers to the right sample to the left, R(2) refers to the second sample to the right, B means the sample below, and RB means the sample right-below. This Mag value is then floor-divided by 2 (e.g. the right shift>>1) and capped at a value of 4. Proper offsets are added depending on the coefficient location within the TU and the TX size. Similarly, the LR range uses 3-neighbors as shown in FIG. 13 with a slightly different derivation rule.

In the proposed design different context derivation neighborhoods may be used for different VCGs:

In one example, different VCGs can use the same context derivation neighborhood as shown in FIG. 13 and with the same context derivation rules.

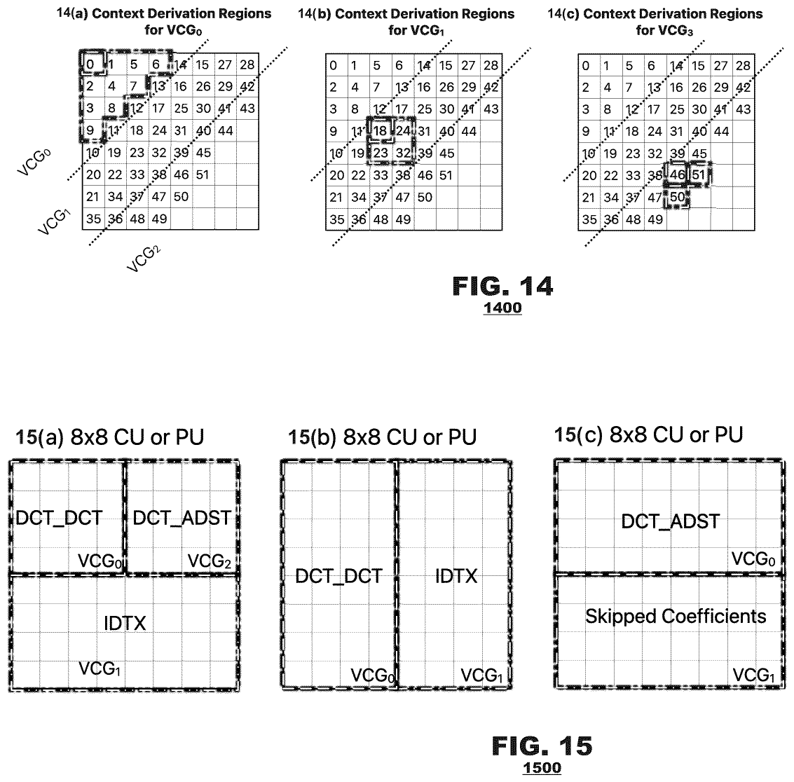

In one example, different VCGs may have different context derivation neighborhoods. One example is provided in FIG. 14 where different VCG₀, VCG₁, and VCG₂ regions are separated diagonally with dashed lines. For the coefficients residing in VCG₀ in FIG. 14(a), to code the level value at coefficient index 0 (or any coefficient index residing in VCG₀), 5-samples to the right and below are used (1, 2, 3, 4, 5). The sum of the level values from this neighborhood is calculated as Mag=R(1)+R(2)+B(1)+B(2)+RB(1) and then passed through an operand (min ((Mag+1)>>1, 4) to determine a context model index. Appropriate offsets can be added to the context index depending on TU size, plane type, transform type, etc. For VCG₁, a different context derivation neighborhood is shown in FIG. 14(b). In this case to encode a level value at coefficient index 18, only 3 samples may be used (23, 24, 32) to compute Mag=R(1)+B(1)+RB(1). Lastly, for VCG₂ as shown in FIG. 14(c), a smaller neighborhood may be used. For instance, to context code the coefficient level at coefficient index 46 the 2-neighbors to the right (51) and below (50) are used Mag=R(1)+B(1).

In one example, VCGs of non-square blocks may have different context derivation neighborhoods than the square blocks. For instance, an asymmetric neighborhood may be used so that more (less) neighboring samples along the longer (shorter) dimension of a non-square transform block are included in the neighborhood. In FIG. 14(a), assuming the block size is 4×8, the neighborhood may be defined by samples (1, 2, 4, 5), so that sample 3 is not used to derive Mag.

In one example, VCGs of different color components (e.g. luma and chroma) may use different neighborhoods and/or rules for context derivation. For example, chroma may use fewer neighboring coefficients to calculate Mag. As another example, VCGs usually are divided further into two or more frequency bands such that the coefficients belonging to a frequency band share the same probability model. A VCG may use different frequency bands for luma and chroma. For example, in FIG. 14, VCG2 may use 3 frequency bands (i.e. three probability models) for luma, while it may use only 1 frequency band (i.e. one probability model) for chroma. This reduces computational complexity, reduces memory consumption, and may also lead to a minor coding gain. For luma, it is useful to have a few probability models in a mid to high frequency VCG, while one may be sufficient for chroma since the data is sparse for it in such region.

In one example, different VCGs may use the same or different context derivation neighborhoods as explained above. However, regardless of the context derivation neighborhood associated with each VCG, FCC may use the same context index derivation rule (e.g. min (Mag+1)>>1, 4) and may use the same offsets.

In one example, different VCGs may use the same or different context derivation neighborhoods as explained above. Moreover, different VCGs may have different context derivation rules. For instance, VCG₀ in FIG. 14(a) can use the following formula min(Mag+T)>>K, L), which could be different from VCG₁. VCG₁ may use an alternative formula, such as min(Mag+1)>>1, 2). In general, an arbitrary function can be associated with deriving an appropriate entropy model or an index associated with that model.

### Other Specializations and Extensions for VCGs:

In one example, different VCGs may have different data hiding properties. For instance, for VCG₀ in FIG. 14(a) sign data hiding (SDH) may be performed only in a particular VCG index (VCG₀). For other VCGs, SDH algorithms may be turned off. To provide a specific example, in both H.265 and H.266 a SDH is performed to hide the sign for a non-zero quantized coefficient to avoid coding it in the bitstream. SDH techniques may be adapted, for example, from those disclosed in Schwarz, Heiko, et al. “Quantization and entropy coding in the versatile video coding (VVC) standard.” IEEE Transactions on Circuits and Systems for Video Technology 31.10 (2021): 3891-3906. This is done by setting up a rule on the parity of the sum of absolute values inside a coding unit or group. In the present invention, SDH algorithm can be only applied to a subset of VCGs where it is beneficial to do so. For instance, SDH rule can be applied for a VCGk and may be disabled for some other VCGj where k is different than j. In a specific embodiment, SDH can only be enabled for VCG₀ in FIG. 12(a) and be turned off for other VCGs.

In one example, the number of non-zero coefficient samples in the VCG₀ in FIG. 14(a) can be calculated. If the number of non-zero samples in VCG₀ is above some threshold (T) parity hiding may be performed at coefficient sample index 0.

In one example, an encoder may perform parity hiding (PH) when encoding level values only for a subset of VCGs. For instance, the encoder may allow PH only for VCG₀ and disallow for other VCGs inside a TU. In another case, in FIG. 9(a), the encoder may define VCGs based on the scan ordering and may perform parity hiding only for VCG₀ or for multiple VCGs (VCG₀, VCG₁, . . . ).

In one example, the sign bit may be context coded only for certain VCGs. For instance, in FIG. 14(a), the sign information may be context coded for the coefficients residing inside the VCG₀ and may be bypass coded for other VCGs.

In one example, different VCGs may use different quantization step sizes or delta QP values. In one case, a single VCG₀ may use a delta quantization such that coefficient values residing inside this VCG are quantized according to step size (Q+deltaQ0) alternatively another VCG₁ may use (Q+deltaQ1), where deltaQ0 and deltaQ1 may have different values. This allows for variable quantization based on where the VCG regions are defined. These quantization related values may be inferred based on the VCG indices and are determined by the decoder based on the location of underlying coefficients. Alternatively, such information can be indicated/signaled at the beginning of each VCG, or at higher-levels such as sequence/picture/tile/CTU levels to indicate the underlying VCGs may share the same quantizers or only a subset of VCGs as defined by their spatial location or index inside a unit will have a pre-defined

In one example, different VCGs may use different quantization matrices, where a quantization matrix belonging to an individual VCG may use variable spatial quantization rules such as different quantization step sizes with respect to coefficient index etc. These quantization matrices may be implicitly defined for individual VCG indices. For instance the VCG₀ in FIG. 12(a) may use a different quantization matrix as compared to VCG₂ in FIG. 12(a). Alternatively, the quantization matrices maybe shared across a subset of VCGs inside a TU/CU. Alternatively to improve coding performance which quantization matrices to apply to VCGs may be signaled at the TU/CU levels or even higher level units such as sequence/picture/frame and tile levels.

In one embodiment, the regions of VCGs may be determined based on a data-driven algorithm, such as k-means clustering with each of the k-VCG regions defined over regions with coefficient magnitudes closer to each other. Such a partitioning can be done offline using pre-defined data using fixed transforms such as the DCT.

In one example, each VCG inside a TU may have different encoder operations. In one example, trellis quantization or coefficient optimization may be disabled for certain VCGs in order to reduce encoding complexity. For instance, in FIG. 14(a), a VCG₀ may be defined to contain coefficient indices 0, 1, and 3; only the top-left 3 coefficients. Coefficient optimization and RDOQ may be turned off for VCG₀. Moreover, coefficient dropout can also be turned off for VCG₀. Moreover, the H.266 coding specification uses a trellis-coded quantization (TCQ) algorithm as described in Schwarz, Heiko (above) where 2 alternative quantizers Q0 and Q1 with multiple trellis states per coefficient. In a specific embodiment, different VCGs may have different TCQ states, and a different number of quantizers. For instance, a VCGk may have m=4 quantizers {Q0, Q1, Q2, Q3} and more number of states associated with it. Another VCGj may have n=2 quantizers {Q0, Q1} and a smaller number of states. In general, different VCGs may have different RDOQ or TCQ rules. Whether a VCG may use a specific RDOQ/TCQ rule may be inferred based on the VCG index k as discussed above. Alternatively, this information may be signaled at the start of a VCG or may be signaled at the higher levels such as CTU/PU/SPS/PPS/tile levels.

In another example, a neural network (NN) algorithm may be provided with sufficient training data, that includes the transform type, coefficient samples, level information, the associated signaling costs for each coefficient index or location, and a number of allowed VCG counts. After sufficient offline training, the NN may determine the optimal symbol counts or syntax element counts across different spatial locations inside a TU for a transform type and the spatial regions of each VCG. In another example, optimal deltaQ0, deltaQ1, deltaQk can be determined using a NN algorithm to perform modified quantization in different VCG regions.

In one embodiment, different VCGs may use different transform types within the FCC framework. For instance, VCGi may use a 2D DCT primary transform and VCGj may use an IDTX transform. Moreover, a secondary transform in a given TU may only apply to certain VCGs. For instance, a secondary transform may only apply to the primary coefficient samples located in VCG₀, but other VCGi s may disable a secondary transform.

As previously explained, VCGs may be defined according to where the underlying coefficients are located inside a given TU e.g. based on scan ordering and scan indices of the underlying coefficients, or based on the row and column indices of underlying coefficients. Some examples were illustrated from FIGS. 7 to 11. Alternatively, VCG regions may be defined across the TU in predefined regions and TU level flags can be coded to indicate which VCGs are considered during coefficient coding. In one example, if a TU contains M VCGs, then a syntax element can be signaled for each VCG to indicate if the each of the M VCGs contain at least one non-zero coefficient. If a VCG has all zero coefficients then a flag/index value can be signaled to indicate the VCG is empty, in which case the coefficients under that VCG are not coded.

In one embodiment, different VCGs may use different predictive coding techniques. For instance, for VCGi differential pulse-code modulation (DPCM) approaches may be used in horizontal mode, where prior to coding quantized or un-quantized coefficient samples a prediction is performed across columns first by taking differences across consecutive column vectors. Likewise, for VCGj a vertical DPCM may be used where prediction can be performed across rows. In general predictive coding may be performed for each VCG differently and can be done either in residual domain (where a transform is skipped) or in the transform (frequency) domain. Since VCGs are defined according to predefined spatial regions over a PU or a TU in preferred embodiments, a mode decision can be associated with a VCG and inferred from the coefficient location as per previous discussion. In an alternative design, mode decisions may be signaled to indicate which mode decisions each VCG should use and such signaling can be done either: 1) at the beginning of each VCG, 2) at the beginning of a subset VCGs if the VCGk index k matches a specific value such as k=0 in FIG. 7(a), 3) at the higher levels such as sequence, picture, tile, CTU levels. If the signaling is done at the higher levels such as sequence, picture, tile levels then all VCGs residing under the same high level unit may share the same mode decisions, or alternatively, a different indicator may be signaled for different VCG indices at the sequence, picture, tile levels. In the latter case, all VCGs at the sequence, picture, tile levels will use the respective modes according to their index over spatial locations as in FIG. 7(a) but different mode indicators will be signaled at the higher levels.

In one embodiment, VCGs may use different modes such as different transform types, predictive coding schemes, quantization matrices/approaches, RDOQ/TCQ rules and quantization states can be signaled for each VCG, depending on if the VCG is active, meaning that a coefficient exists in a given VCG region then a mode/flag/index or indicator related to a transform type, secondary transform type, or zero-out, or predictive coding scheme can be signaled for that VCG. In one example, if a TU is split into two VCG regions, then VCG₀ can signal a transform type, or a DPCM direction mode. Alternatively, VCG₁ can signal another transform type or another DPCM direction mode. In general arbitrary mode decisions may be signaled for individual VCGs.

In another case, a higher level flag in a sequence parameter set (SPS), picture parameter set (PPS), or a tile level flag or a CTU level flag can be signaled to indicate if a PU or TU is split into VCGs or not. In this case, a high-level flag value of 0 may indicate there is no multiple VCGs in a given TU/PU and the entire TU uses the same coefficient coding method. Alternatively, a non-zero high-level flag value may indicate that there is VCG splits in the given frame/tile/CTU where each TU may have a fixed N number of VCGs. Alternatively, a higher level index may also be signaled to specify how many (N) VCGs the present frame/tile/CTU contains per PU/TU.

In one embodiment, a higher level unit such as a CTU, a CU or a PU may be split into multiple VCGs. In this case, differently from the embodiments discussed above a VCG is not defined within a TU. Instead, a VCG may contain multiple TUs inside it. For instance in FIG. 15(a), a CU/PU is split into 3 VCGs where each VCG may have a different transform type associated. The transform type that corresponds to each VCG location can be pre-defined and inferred by the decoder. In this case transform type for a given VCG will not be signaled at TU level. Instead a VCG split mode can be signaled at the CTU/CU/PU levels to indicate the decoder that a given CTU/CU/PU will have an inferred transform type in different regions. In another case, a VCG mode can be signaled at the CTU/CU/PU levels to indicate that a CTU/CU/PU will have 2 VCG regions with a vertical split as in FIG. 15(b), where the leftmost VCG will always use a DCT_DCT transform and the rightmost VCG will always use an IDTX transform. In another example in FIG. 15(c), another VCG index can be signaled at the CTU/PU/CU levels to indicate a horizontal split where the top VCG will have DCT_ADST transform and the bottom VCG will skip coefficient coding all together. This means that in FIG. 15(c), VCG₁ will not code coefficients for half of the CTU/CU/PU. This flexibility allows the encoder to split a higher level block according to pre-defined regions and based on the signaled VCG mode index at the CTU/CU/PU save from lower level signaling of transform type at TU level.

In one embodiment, if information pertaining to VCG modes are signaled such signaling can be performed at various units:
A CU or PU level VCG mode (cu_vcg_mode, pu_vcg_mode) can be signaled to indicate a present CU or PU will have different spatial partitions such as the examples presented in FIG. 15,
A CU or PU level VCG mode (cu_vcg_mode, pu_vcg_mode) can be signaled to indicate a present CU or PU will have different spatial partitions such as the examples presented in FIG. 15 and that each VCG may use a different transform type, the transform types for each VCG may be pre-defined and inferred from the (cu_vcg_mode, pu_vcg_mode) as well as they may be signaled per VCG.
A TU level VCG index (tu_vcg_index) may be signaled to indicate whether a present TU may have different spatial partitioning and coefficient coding rules for individual TUs,
A CTU/SPS/PPS or tile level flag to indicate at the higher level VCG-based partitioning, coefficient coding and transform type inference is turned on or off,

If a mode/flag/index is signaled for VCGs at CU/PU/CTU levels then this information can be either coded with contexts using an arithmetic coder or can be coded in bypass mode. If context coding is used, the mode decisions from previous CU/PU/CTU levels can be used to select different entropy models to more efficiently encode the VCG mode/index for the current units.

FIG. 16 illustrates a decoding system 1600 that may find application with the aspects disclosed hereinabove. FIG. 16 illustrates components of a decoding system that process coded blocks such as TUs, CUs, and/or PUs.

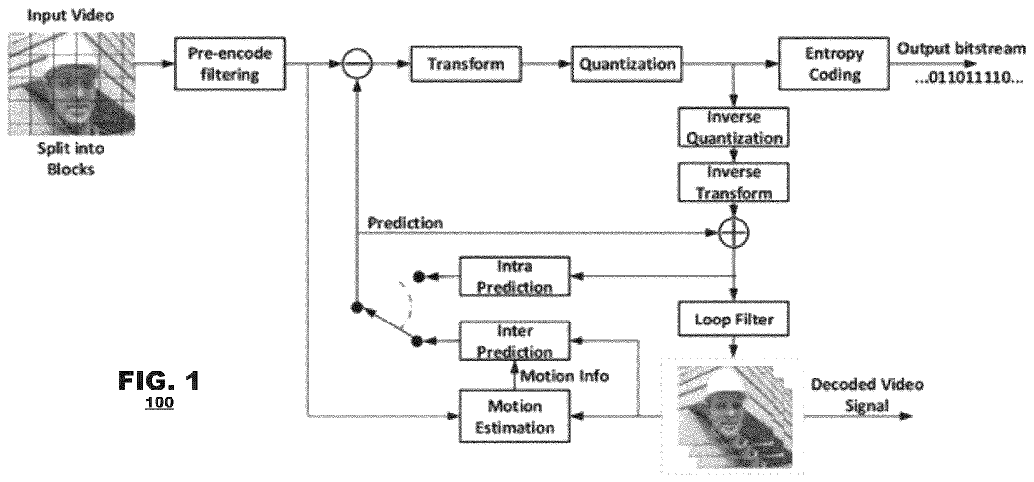

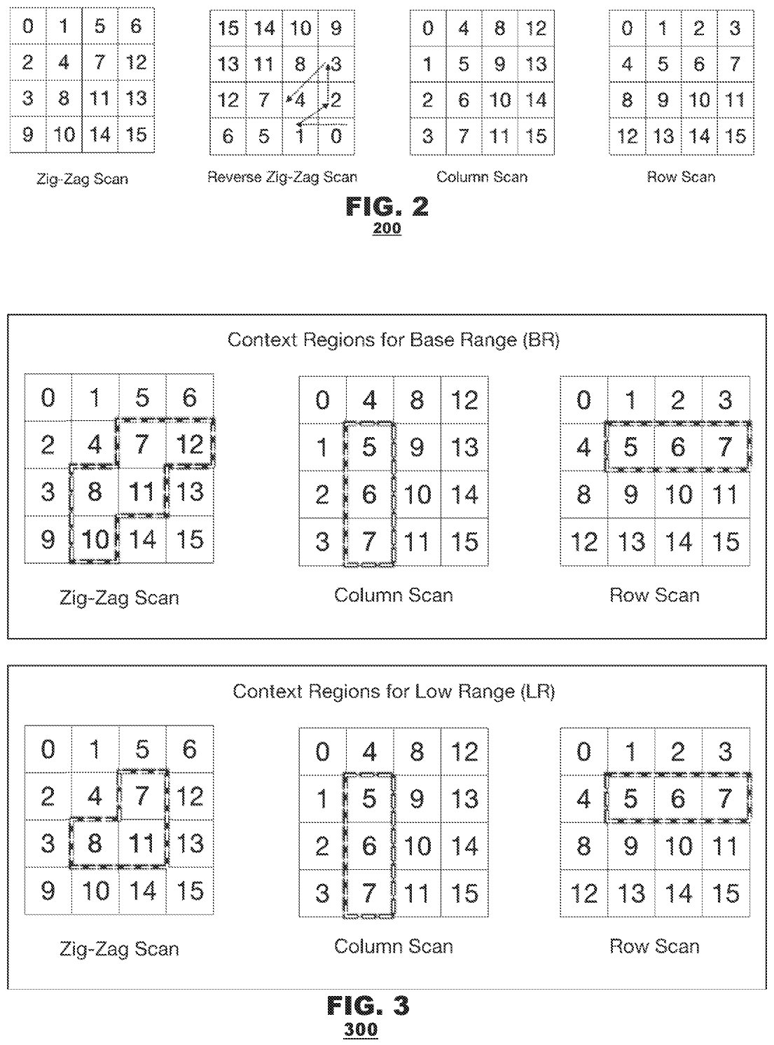

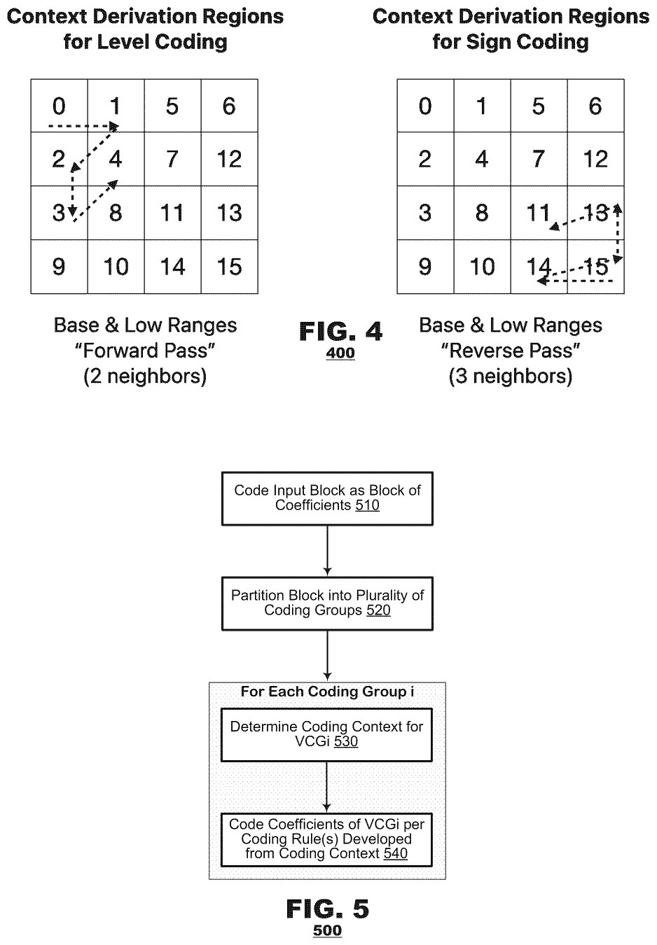

The decoding system 1600 may include an entropy decoder 1610, an inverse quantizer 1620, an inverse transform 1630, an adder 1640, a loop filter 1650, a prediction unit 1660, and a reference picture buffer 1670 all operating under control of a controller 1680. The entropy decoder 1610, inverse quantizer 1620, inverse transform 1630, and adder 1640 each perform operations that invert operations applied by their counterparts in the encoder shown in FIG. 1. Thus, the entropy coder may perform entropy coding applied by the encoder; in embodiments where entropy coding is performed differently among the VCGs, the controller 1680 may cause the entropy decoder 1610 to apply a like-kind decoding to data according to the VCG to which it belongs. Similarly, the inverse quantizer 1620 may apply dequantization to data output by the entropy decoder according to quantization parameters applied by an encoder; in embodiments where quantization is performed differently among the VCGs, the controller 1680 may cause the inverse quantizer 1620 to apply a like-kind dequantization to data according to the VCG to which it belongs. The inverse transform 1630 inverts transform processes applied by an encoder; again, the controller 1680 may cause the inverse transform 1630 to apply a like-kind transform processing to data according to the VCG to which it belongs.

The prediction unit 1660 may perform prediction according to a prediction mode and prediction references supplied in the coded video data. The prediction unit 1660 may generate prediction coding from reference picture data stored in a reference picture buffer 1670 and may supply a prediction block to the adder 1640. The adder 1640 may add recovered data output from the inverse transform unit 1630 to prediction content from the prediction unit 1660 on a pixelwise basis.

The in-loop filter 1650 may perform certain filtering operations on recovered pixel blocks output by the adder 1640. For example, the in-loop filter 1640 may include a deblocking filter, a sample adaptive offset (“SAO”) filter, and/or other types of in loop filters. The in-loop filter may operate on frames assembled from multiple pixel blocks generated by the decoding system 1600. Reassembled reference frames may be stored in the reference picture buffer 1670 for use in decoding of later-received video.

The foregoing discussion has described operation of the aspects of the present disclosure in the context of video coders and decoders. Commonly, these components are provided as electronic devices. Video decoders and/or controllers can be embodied in integrated circuits, such as application specific integrated circuits, field programmable gate arrays, and/or digital signal processors. Alternatively, they can be embodied in computer programs that execute on camera devices, personal computers, notebook computers, tablet computers, smartphones, or computer servers. Such computer programs typically are stored in physical storage media such as electronic-, magnetic-, and/or optically-based storage devices, where they are read to a processor and executed. Decoders commonly are packaged in consumer electronics devices, such as smartphones, tablet computers, gaming systems, DVD players, portable media players and the like; and they also can be packaged in consumer software applications such as video games, media players, media editors, and the like. And, of course, these components may be provided as hybrid systems that distribute functionality across dedicated hardware components and programmed general-purpose processors, as desired.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A video coding method, comprising:
coding an input block of video content according to an operation yielding a block of coefficients,
organizing the block of coefficients into a plurality of coding groups,
coding the coefficients of each of the coding groups according to coding rules, the coding rules varying between the coding groups.

2. The method of claim 1, wherein the block of coefficients has a rectangular shape, and at least one of the coding groups has a non-rectangular shape.

3. The method of claim 2, wherein the non-rectangular shape of at least one coding group is triangular.

4. The method of claim 1, wherein coefficients are assigned to the coding groups according to their respective positions in the block of coefficients in an entropy coding scan direction.

5. The method of claim 1, wherein coefficients are assigned to the coding groups according to their respective columnar positions in the block of coefficients.

6. The method of claim 1, wherein coefficients are assigned to the coding groups according to their respective row positions in the block of coefficients.

7. The method of claim 1, wherein coefficients of two different coding groups have different formats from each other.

8. The method of claim 1, wherein the coefficients are transform coefficients obtained by a transform operation.

9. The method of claim 1, wherein the coefficients are quantized coefficients obtained following a quantization operation.

10. The method of claim 1, wherein the coefficients are quantized coefficients obtained following a prediction operation.

11. The method of claim 1, wherein the coefficients are unquantized coefficients obtained after bypassing a quantization operation.

12. The method of claim 1, wherein the input block is a transform unit according to a coding protocol for the video coding.

13. The method of claim 1, wherein the input block is a prediction unit according to a coding protocol for the video coding.

14. The method of claim 1, wherein the coding rules apply first number of symbols to represent coefficient value levels in a first coding group and a second number of symbols, different from the first number, to represent coefficient value levels in a second coding group.

15. The method of claim 1, wherein the coding rules apply quantization parameters to the coefficients in a first and second coding group, wherein the quantization parameters of the first coding group are derived according to a different process than for derivation of quantization parameters for a second coding group.

16. The method of claim 1, wherein different coding rules apply to blocks of different color components.

17. The method of claim 1, wherein the coding rules apply different entropy coding processes to coefficients in a first coding group than for transform coefficients in a second coding group.

18. The method of claim 1, wherein the coding rules apply different entropy modeling for coefficients in a first coding group than for transform coefficients in a second coding group.

19. The method of claim 1, wherein the coding rules apply different sign bit coding processes to coefficients in a first coding group than for transform coefficients in a second coding group.

20. The method of claim 1, wherein the coding rules apply different sign hiding processes to coefficients in a first coding group than for coefficients in a second coding group.

21. The method of claim 1, wherein the coding rules apply different parity bit coding processes to coefficients in a first coding group than for coefficients in a second coding group.

22. The method of claim 1, further comprising signaling information of the coding group in a syntax element of a coding unit.

23. The method of claim 1, further comprising repeating the method for a plurality of input blocks of video content, wherein partitions of a transform block obtained by the organizing step for one input block are different than partitions of a transform block obtained by the organizing step for another input block.

24. The method of claim 1, further comprising repeating the method for a plurality of input blocks each representing a different color component of video content, wherein a number of partitions of a first input block are different than a number of partitions of a second input block.

25. The method of claim 24, wherein the number of partitions for an input block representing a luminance color component is greater than the number of partitions for an input block representing a chrominance color component.

26. The method of claim 24, wherein entropy coding of an input block representing a luminance color component is represented by a relatively larger number of symbols per sample than symbols for entropy coding of an input block representing a chrominance color component.

27. The method of claim 1, wherein the coding rules apply first number of syntax elements to represent coefficient value levels in a first coding group and a second number of syntax elements, different from the first number, to represent coefficient value levels in a second coding group.

28. The method of claim 1, wherein coefficients are assigned to the coding groups according to color component information in the block of coefficients.

29. The method of claim 1, wherein the coding rules apply different entropy coding processes to coefficients in a first coding group than for coefficients in a second coding group for different color components.

30. The method of claim 1, wherein the coding rules apply different entropy modeling for coefficients in a first coding group than for coefficients in a second coding group for different color components.

31. The method of claim 1, wherein the coding rules apply different residual coding methods for coefficients in a first coding group than for coefficients in a second coding group.

32. The method of claim 1, wherein the coding rules apply a different selection of cumulative distribution functions for entropy coding for coefficients in a first coding group than cumulative distribution functions for coefficients in a second coding group.

33. The method of claim 1, wherein the coding rules apply a different selection of context derivation rules for entropy modeling of coefficients in a first coding group than context derivation rules for entropy modeling of coefficients in a second coding group.

34. The method of claim 33, wherein there are different sets of context derivation rules for coding groups of luminance coefficients than for coding groups of chrominance coefficients group.

35. The method of claim 1, wherein the coding rules apply a different selection of context indices and increments for entropy modeling of coefficients in a first coding group than context indices and increments for entropy modeling of coefficients in a second coding group.

36. The method of claim 1, further comprising signaling information of the coding group in a syntax element of a prediction unit.

37. A video decoding method, comprising:
identifying portions of coded video that correspond to different decoding groups of a block of coded coefficients,
decoding a first portion of coded video corresponding to a decoding group according to a first decoding rule,
decoding a second portion of coded video corresponding to a decoding group according to a second decoding rule,
assembling a block of decoded coefficients from the decoded first and second portions of coded video, and
applying the assembled block of coefficients to another block decoding process.

38. The method of claim 37, wherein the coefficients are coded transform coefficients and the decoded first and second portions of coded video are inverse transformed coefficients.

39. The method of claim 37, wherein coefficients are assigned to the decoding groups according to their respective positions in the block of coefficients in an entropy coding scan direction.

40. The method of claim 37, wherein coefficients are assigned to the decoding groups according to their respective columnar position in the block of coefficients.

41. The method of claim 37, wherein the block of coefficients has a rectangular shape, and at least one of the decoding groups has a non-rectangular shape.

42. The method of claim 41, wherein coefficients are assigned to the decoding groups according to their respective row position in the block of coefficients.

43. The method of claim 41, wherein the decoding rules interpret coefficient value levels in a first decoding group according to a first number of symbols and interpret coefficient value levels in a second decoding group according to a second number of symbols, different from the first number of symbols.

44. The method of claim 41, wherein the decoding rules apply different entropy decoding processes to coded coefficients in a first decoding group than for coded coefficients in a second decoding group.

45. The method of claim 41, wherein the decoding rules apply different entropy modeling for coded coefficients in a first decoding group than for coded coefficients in a second decoding group.

46. The method of claim 41, wherein the decoding rules apply a different selection of cumulative distribution functions for entropy decoding for coefficients in a first decoding group than cumulative distribution functions for coefficients in a second decoding group.

47. The method of claim 41, wherein the decoding rules apply a different selection of context derivation rules for entropy modeling of coefficients in a first decoding group than context derivation rules for entropy modeling of coefficients in a second decoding group.

48. The method of claim 41, wherein the decoding rules apply a different selection of context indices and increments for entropy modeling of coefficients in a first decoding group than context indices and increments for entropy modeling of coefficients in a second decoding group.

49. The method of claim 41, wherein the decoding rules apply different sign bit decoding processes to coefficients in a first decoding group than for coefficients in a second decoding group.

50. The method of claim 41, wherein coefficients are assigned to the decoding groups according to their respective color component information in the block of coefficients.

51. The method of claim 41, wherein the decoding rules interpret coefficient value levels in a first decoding group according to a first number of symbols and interpret coefficient value levels in a second decoding group according to a second number of symbols, different from the first number of symbols.

52. A method, comprising:
organizing a prediction unit into a plurality of coding groups,
coding each of the coding groups according to a respective set of coding rules that are different from each other, including applying a different transform type to content of the different coding groups.

53. The method of claim 52, further comprising signaling the prediction unit organization by a mode identifier.

54. The method of claim 53, wherein a mode identifier indicates that the prediction unit is to be divided along a vertical axis of the prediction unit.

55. The method of claim 53, wherein a mode identifier indicates that the prediction unit is to be divided along a horizontal axis of the prediction unit.
